(19) United States
(12) Patent Application Publication
(10) Pub. No.: US 2006/0229888 A1
(43) Pub. Date: Oct. 12, 2006

(54) Defining transaction processing for a computer application

(76) Inventors: Renzo Colle, Rastatt (DE); Daniel Zoch, Walldorf (DE); Henrik Saterdag, Weinheim (DE)

Correspondence Address: FISH & RICHARDSON, P.C., PO BOX 1022, MINNEAPOLIS, MN, 55440-1022, US

(21) Appl. No.: 11/094,744

(22) Filed: Mar. 31, 2005

(51) Int. Cl. G06Q 99/00

(52) U.S. Cl. 705/1

(57) ABSTRACT

A user, such as a computer programmer, computer architect, or software developer, is able to configure a software framework to define business processing to be performed on a business object type by a computer application. To do so, the user associates methods (or other types of collections of computer instructions) with particular points in a generic processing flow that is supported by the business processing framework. At runtime, the business processing framework executes methods associated with particular points in the processing flow for a the business object when the computer system executing the computer application reaches a point in a business process for a business object of the type for which the business processing framework is configured.

### TECHNICAL FIELD

This description relates to techniques for defining transaction processing performed by computer systems.

### BACKGROUND

Enterprise information technology (IT) systems often are used to manage and process business data. To do so, a business enterprise may use various application programs running on one or more enterprise IT systems. Application programs may be used to process business transactions, such as taking and fulfilling customer orders, providing supply chain and inventory management, performing human resource management functions, and performing financial management functions. Application programs also may be used for analyzing data, including analyzing data obtained through transaction processing systems. In many cases, application programs used by a business enterprise are developed by a commercial software developer for sale to, and use by, many business enterprises.

An application program may be designed to meet the specific requirements of the environment in which the application program is operating. Some commercial application program may be designed for use by many business enterprises that are in a particular industry or in a particular geographic region. In some cases, a more-generalized commercial application program may be modified for more specialized use by many business enterprises. Such modifications may be performed by the same business enterprise that developed the more-generalized commercial application program, or such modifications may be performed by a different business enterprise, which may be referred to as a “business partner” of the business enterprise that developed the more-generalized commercial application program. In some cases, modifications may be made to the application program to meet the specific requirements of business enterprises in a particular industry or a particular geographic region, or to meet the specific requirements of a particular business enterprise or a particular department in a business enterprise. Examples of such modification include customization of the data model, the process model, or the user interface of the application. Modification of an application program may require knowledge of the data model, the process model, and/or the user interface of the application program. Modification of an application program also may require knowledge of programming techniques used to develop the application program.

### SUMMARY

Generally, the described techniques enable a user, such as a computer programmer, computer architect, or software developer, to define business processing to be performed by a type of application transaction data (such as a business object) using a generic processing model. At runtime, the defined process is then executed for application transaction data. More particularly, a user of a software development tool configures a business processing framework to define business processing to be performed on a business object type. To do so, the user associates methods (or other types of collections of computer instructions) with particular points in a generic processing flow supported by the business processing framework. A method or another type of collection of computer instructions may be referred to as an instruction module.

At runtime, when the computer system executing the computer application reaches a point in a business process for a business object of the type for which the business processing framework is configured, the method associated with the particular point is executed for the business object. In this manner, a business process executed by the business processing framework is able to be added to, or modified in, a computer application.

In one general aspect, transaction data is processed by receiving an indication of a change in data associated with an instance of a business object being processed. The business object instance has multiple attribute values. An indication is also received of an execution point of multiple execution points in a predefined processing flow. A business object type is identified that is associated with the business object instance. User-defined configuration information is accessed to determine a data-validation instruction module and a data-determination instruction module to be performed based on the change in the data associated with the business object instance, the business object type and the execution point. A data-validation instruction module is an instruction module that returns, to a calling computer application, only a status indicator reflecting consistency of data related to the business object instance. A data-determination instruction module is a instruction module that makes available, to another instruction module, data related to the business object instance such that the related data made available is different from data that was associated with the business object instance prior to the execution of the data-determination instruction module.

Implementations may include one or more of the following features. For example, the data-validation instruction module may be executed prior to the execution of the data-determination instruction module. Alternatively, the data-validation instruction module may be executed after the execution of the data-determination instruction module.

An entry of configuration information may be associated with one of multiple business object types, with one of multiple execution point types, and with a type of multiple types of data changes. A business process component may be situated between a user interface layer and a data access layer such that the business process component communicates with at least one user interface process and communicates with at least one data access process.

The data change may include a change of an attribute value of the business object. The related data that is made available may include an attribute that is determined based on an attribute of the business object instance. The business object instance may include one or more subcomponents, with each subcomponent having one or more associated attribute values. The data change may include a change of an attribute value of one of the sub-components of the business object instance. The data-determination instruction module may make available a subcomponent of the business object instance having associated attribute values.

A trigger for a service may be received where the trigger is associated with the business object type. User-defined configuration information may be accessed to determine an action-validation instruction module and an action-execution instruction module. The action-validation instruction module and the action-execution may be associated with the triggered service. The action-validation instruction module returns an indication whether the action-execution instruction module is permitted to be performed on the business object instance. The determined action-validation instruction module associated with the service is executed prior to the execution of the determined action-execution instruction module.

User-defined configuration information may be accessed to determine an action-preparation instruction module that is associated with the triggered service. The action-preparation instruction module may retrieve additional data related to the business object instance, and the determined action-preparation instruction module is executed prior to the execution of the determined action-validation instruction module.

Data transaction processing may be configured by receiving user-defined configuration information including an indication of a data-validation instruction module, an indication of a data-determination instruction module, an indication of a type of change, an indication of a business object type, and an indication of an execution point. The user-defined configuration information may be stored for later use in controlling data transaction processing at runtime. The user-defined configuration information also may include an indication of an action-preparation instruction module, an indication of an action-execution instruction module, an indication of a trigger, and an indication of a business object type.

Implementations of the techniques discussed above may include a method or process, a system or apparatus, or computer software on a computer-accessible medium. The details of one or more of the implementations are set forth in the accompanying drawings and description below. Other features will be apparent from the description and drawings, and from the claims.

The described techniques may help to reduce application development or modification effort by decreasing application complexity, increasing modularization of application program code or instructions, increasing reuse of application program code or instructions, and/or increasing comprehensibility of application processing. The described techniques also may help to increase ease of application development, customization or maintenance.

### DESCRIPTION OF DRAWINGS

FIG. 1 is a block diagram of a system incorporating various aspects of the invention.

FIG. 2 is a flow chart of a process for defining processing to be performed by a type of business object.

FIG. 3 is a block diagram of an example user interface for defining and viewing business processing to be performed for a business object type.

FIGS. 4 and 5 are flow charts of processes for executing a business process defined by a user.

FIG. 6 is a block diagram of an example of how a business process framework controls processing of a business object at runtime.

Like reference symbols in the various drawings indicate like elements.

### DETAILED DESCRIPTION

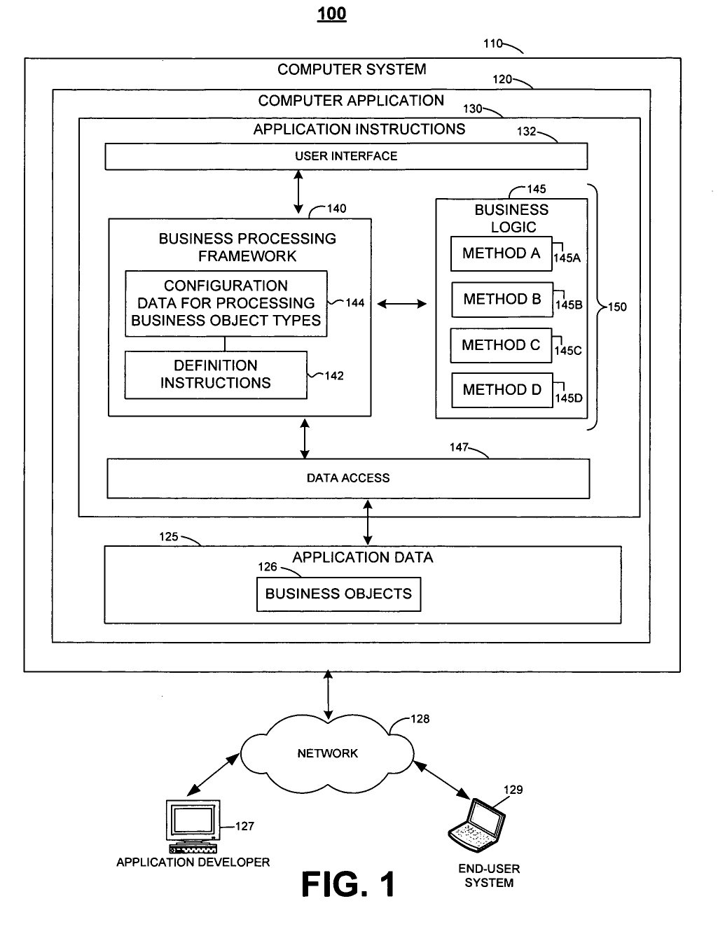

FIG. 1 shows a block diagram of a system 100 of networked computers, including a computer system 110 capable of operating a computer application 120 having application data 125 that includes business objects 126 and application instructions 130. In general, a user, such as an application developer, a software developer, or a computer programmer, uses a computer system 127 to access the computer system 110 over a network 128 to configure a business processing framework 140 to control processing of business objects 126 by the computer application 120. At runtime, an end-user uses a computer system 129 to create and revise business objects (or other types of application data) that are processed by the computer application 120 according to the configuration of the business process framework 140.

More particularly, the system 100 includes the computer systems 110, 127 and 129, all of which are capable of executing instructions on data and all of which are interconnected via the network 128. Examples of the network 128 include the Internet, wide area networks (WANs), local area networks (LANs), or any other wired or wireless network. The developer system 127 and the end-user system 129 each may be a general-purpose computer that is capable of operating as a client of the application program 120 (such as a desktop personal computer, a workstation, or a laptop computer running an application program), or a more special-purpose computer (such as a device specifically programmed to operate as a client of the particular application program 120). For brevity, FIG. 1 illustrates only a single developer system 127 and a single end-user system 129 for system 100. However, actual implementations may include multiple developer systems and multiple end-user computer systems.

The computer system 110 may be a general-purpose computer or a special-purpose computer. The computer system 110 includes a computer application 120 having application data 125. A particular portion of data, here referred to as business objects 126, is stored in application data 125 and includes multiple business objects. Each business object in business objects 126 is a collection of data attribute values, and typically is associated with a principal entity represented in a computing device or a computing system. Examples of a business object include information about a customer, an employee, a product, a business partner, a product, a sales invoice, and a sales order. Business objects associated with a principal entity may be referred to as master data. Some implementations make a distinction between a master data object that refers to a principal entity and a transaction object that refers to a master data object. For example, a sales order object may be a transaction object that refers to a customer object, a type of master data object. A business object may be stored as a row in a relational database table, an object instance in an object-oriented database, data in an extensible mark-up language (XML) file, or a record in a data file. Attributes are associated with a business object. A business object may be referred to as an instance of a business object class or an instance of a type of business object. The business object class or type of business object identifies a series of attributes that are associated with each instance of a business object class or type of business object. A business object includes attribute values for attributes identified for the type of the business object.

In one example of a business object, a customer business object may be associated with a series of attribute values including a customer number uniquely identifying the customer, a first name, a last name, an electronic mail address, a mailing address, a daytime telephone number, an evening telephone number, date of first purchase by the customer, and date of the most recent purchase by the customer. In another example, a sales order business object may include a customer number of the purchaser, the date on which the sales order was placed, and a list of products, services, or both products and services purchased. In yet another example, a return request business object may include a customer number of the purchaser, an item number of the purchased item that the customer wishes to return, date on which the request was received, and an indication whether the return request was approved.

In some implementations, a business object may refer to another business object. A business object that refers to another business object may be called a referring business object or a dependent business object. The referring object also may be called a sub-component of a business object. The business object to which the referring business object refers may be called a parent business object, and the referring business object may be called a child business object. For example, an employee object may be associated with a series of attribute values (such as first name, last name, and employee identification number) and may be related to two telephone-number referring objects (that each are associated with a particular telephone number) and a work-address referring object (that is associated with address attribute values, such as street address, city, state, zip code, and country). The application instructions 130 include instructions 132 for displaying and controlling a user interface that enables an end-user using the end-user computer system 129 to create and/or revise business objects 126 or other types of application data 125. The user interface instructions 132 may be referred to as a user interface layer.

The application instructions 130 also include instructions 140 for the business processing framework. The business processing framework 140 includes definition instructions 142 for displaying and controlling a user interface that enables an application developer using computer system 127 to define processing to be performed, at runtime, for a particular type of business object by configuring the business processing framework 140.

In general, the application developer uses the user interface of the business processing framework 140 to identify one or more collections 145A-145D of business logic 145 to be executed at one of multiple, predetermined execution points of the computer application 120at runtime. Each method of 145A-145D may be a data validation method or an application processing logic method, as described more fully later. A collection of business logic may be referred to as an instruction module. In response to information entered by the application developer, the definition instructions 142, when executed, store configuration data 144 used by the business processing framework 140 to control processing of business objects 126 at runtime. Another example of a collection of business logic may be a computer function or a computer program. Collections of business logic that may be executed by the computer application 110 also may be referred to as a business process.

The predetermined execution points generally describe a generic implementation process that may be applied to multiple, different types of business objects. By iteratively defining one or more methods to be executed at one of the predetermined execution points, the application developer is able to define, or model, business processing to be performed for types of business objects. The separation of data validation methods that check the consistency of a business object from methods having other types of application processing logic may be useful. For example, a data validation method can be used to check consistency of data at multiple processing points. In other words, a data validation method may be reused at different processing points. This may help to reduce effort required to develop or modify a computer application.

In some implementations, the application developer also may use the business processing framework 140 to define one or more collections 145A-145D of business logic 145 that are to be executed at runtime of the computer application 120, where the one or more collections 145A-145D are executed in response to a trigger received at runtime. The business processing framework 140 and the business logic 145 collectively may be referred to as a business processing layer 150.

The business processing framework 140 interfaces, at runtime, with the user interface layer 132 and with data access instructions 147. The data access instructions 147 may be referred to as a data access layer or a database layer. The data access instructions 147 directly access the application data 125, which may be stored in a database or other type of collection of data. The business processing framework 140 may be said to be situated between the user interface layer 132 and the data access layer 147. A business object is processed, at runtime, by the business processing framework 140 based on the configuration data 144 of the business processing framework 140.

The computer application 120 may be a commercial computer application that is developed and licensed (or sold) by a commercial software developer that is different from the business entity that uses the system 100. The computer application 120 may not necessarily include the definition instructions 142 for configuring the business processing framework. The definition instructions 142 may be licensed or sold as part of a software development application for use by multiple, different business entities to modify computer applications or to modify a particular computer application.

In yet another example, the computer application 120 and the definition instructions 142 may be part of a suite of commercial computer applications that are developed and licensed (or sold) by a commercial software developer for use by multiple, different business entities in modifying the computer application.

As illustrated in FIG. 1, the business processing framework 140 and the business logic 145 is separate from the user interface 132. The user interface 132 is one example of a computer program that logically uses services provided by the business processing layer 150. Alternatively or additionally to the user interface 132, the business processing framework 140 may interface with a batch process or a printing application. The business processing framework 140 also may communicate with a system application that sends messages to, or receives messages from, an external computer system. One example of such a system application is an application that receives XML messages over the Internet.

For brevity, FIG. 1 illustrates using a single computer system 110 that is accessed both by application developers for configuring the business processing framework 140 and by end-users for using the application program to operate on transaction data. However, actual implementations may include separate computer systems to configure the business processing framework 140 and to operate the application program to process transaction data. This may be particularly true when a commercial software developer is defining business processes for business objects that are to be included in software intended for use by many, different business enterprises. In such a case, for example, instructions for configuring the business processing framework may be included in a separate application or software development tool that is not part of the computer application 120.

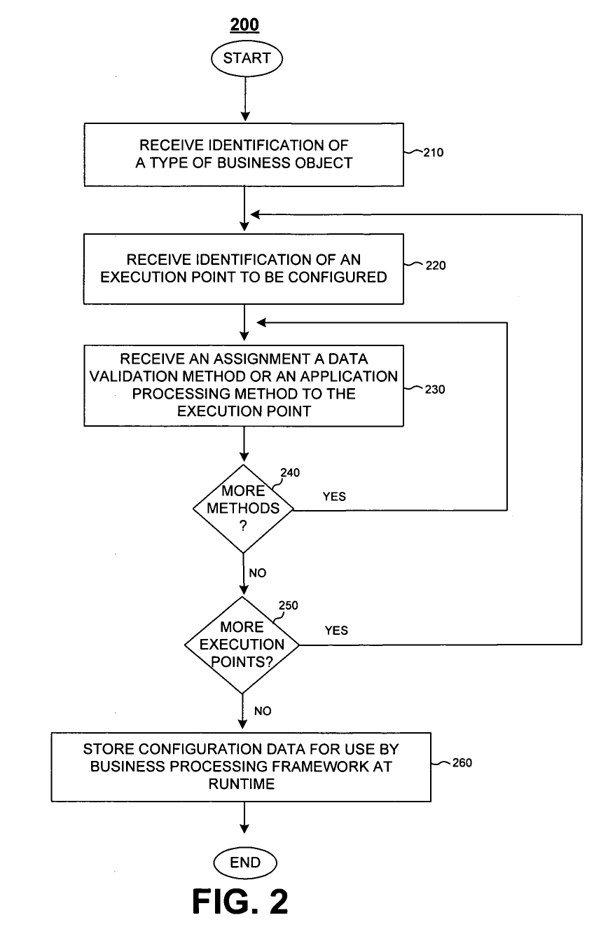

FIG. 2 illustrates a process 200 for defining processing to be performed for a type of business object. The process 200 may be performed by one or more processors in a system, such as, for example, the computer system 110 in FIG. 1. The processor is directed by a method, script, or other type of computer program that includes instructions for performing the process 200. Examples of such a collection of instructions include the definition instructions 142 of the business processing framework 140 in FIG. 1. The process 200 may be manually initiated by an application developer, software developer, computer programmer or another type of user who desires to define a business process for later execution at runtime.

In general, to define or modify a process to be performed by a computer application, a person accesses a user interface displayed on a computer system that enables a user to create or revise configuration information for the business processing framework. The user-entered information is received by the processor and stored as configuration information used by business processing framework to control the processing of a business object at runtime.

More particularly, the processor executing the process 200 receives, from a user, identification of a type of business object (step 210). For example, a user may select a type of business object from a list or a menu of business object types, or a user may identify a business object type by keying an identifier or name that identifies a type of business object. Examples of a business object type include a sales order, a sales opportunity, and a request to return a previously purchased product.

The processor receives, from the user, identification of an execution point to be configured (step 220). This may be accomplished, for example, by a user selecting one from a list of multiple execution points that are generally applicable to multiple types of business objects or that are specifically applicable to the type of business object identified in step 210. Examples of execution points include a point when a business object of the business object type is created, a point when a business object of the business object type is changed, a point when a business object of the business object type is read from persistent data storage (such as a database), a point when a business object of the business object type is loaded into a computer memory (such as a memory buffer or storage cache), or a point when a business object of the business object type is provided to a user interface layer of a computer application.

The processor receives an indication of a data validation method or an application processing method to be assigned to the execution point (step 230). A data validation method is a set of computer instructions that returns, to a calling computer application, only a status indicator reflecting consistency of data related to the business object instance. A data validation method also may be referred to as a data validation instruction module.

An application processing method is a collection of computer instructions that makes available, to another method, data related to the business object instance being processed, where the related data made available is different from data that was associated with the business object instance prior to the execution of the determined method. An application processing method also may be referred to as a data determination method. For example, an application processing method may compute, calculate or otherwise determine a value based on stored business object data. In one example, total cost of a sales order may be calculated based on individual product prices and quantities of products included in a sales order. In another example, age of a customer may be determined based on a customer's birthday and the current date. An application processing method also may access a business object that is related to the business object being processed, for example, a referring or dependent business object may be accessed.

The processor receives an indication whether the user desires to assign another method to the execution point for the business object type (step 240), and, if so, receives an assignment of another method (step 230). When the user has completed assigning methods to the identified execution point (step 240), the processor receives an indication whether the user desires to configure a different execution point for the business object type (step 250) and, if so, the processor receives an identification of another execution point (step 220).

When the user has completed assigning methods to executions points for the business object type (step 250), the processor stores the configuration data, including the assignment of methods to execution points for the business object type, so that the configuration data is made available for use by the business processing framework at runtime (step 260), and the process 200 ends.

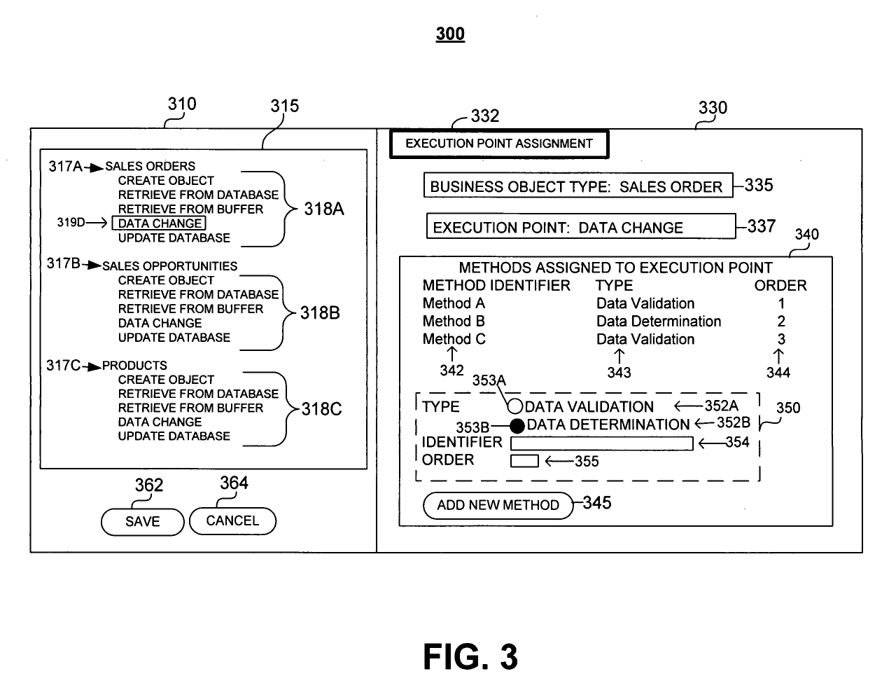

FIG. 3 illustrates an example of a user interface 300 that may be displayed to a user who is configuring business processing to be performed for a business object type. The user interface 300 includes a business object type window 310 that displays a list 315 of business object types 317A-317C for which business processing has been configured, or may be configured, using the user interface 300.

The list 315 displayed in the business object type window 310 includes a list of execution points that are associated with each business object type. In particular, under each name of a business object type 317A, 317B or 317C, the execution points 318A, 318B or 318C that are applied to the business object type are displayed. More particularly, execution points 318A are applied to a sales order 317A, execution points 318B are applied to a sales opportunity 317B, and execution points 318C are applied to a product 317C. As shown, the same execution points 318A, 318B and 318C are applied to each business object type, though this need not necessarily be so.

The user interface 300 also includes an execution point assignment window 330 that displays information related to the particular execution point for a particular business object type that is highlighted in the business object type window 310. As illustrated, a data change execution point 319D for a sales order business type 318A is highlighted in the business object type window 310. The assignment window 330 identifies the business object type 335 and execution point 337 for which the methods identified in a method window 340 apply.

The method window 340 identifies the methods to be executed and the order in which the methods are executed when a business object of the business object type 335 reaches the identified execution point 337. More particularly, the method window lists a method identifier 342, a type 343 of method, and an order 344 of execution for each method. The method window 340 also includes a control 345 operable to display a method-definition window 350 that enables a user to define a method to be assigned to the identified execution point 337 for the identified business object type 335.

The method definition window 350 displays types 352A and 352B that are selectable, using controls 353A and 353B, to identify a type of the method to be added. In the example of user interface 300, types of methods include a data validation method 352A selectable with control 353A and a data determination method 352B selectable with control 353B. As shown, a data determination method is to be added. A data determination method is a type of method that uses known data (such as data persistently stored with a business object) to determine other data (such as calculated data or a dependent or related business object), and as such, a data determination method may be referred to as a type of method that performs application processing logic (as opposed to data validation).

The method-definition window 350 also includes a field 354 to identify the method identifier and a field 355 to identify the order of execution of the new method relative to execution order of the methods identified in window 340.

The user interface 300 also includes a save control 362 operable to save the configuration information identified in the method window 340 for later use by the business processing framework and to remove the user interface 300 from display. The user interface 300 also includes a cancel control 364 to remove the user interface 300 from display without saving the configuration information.

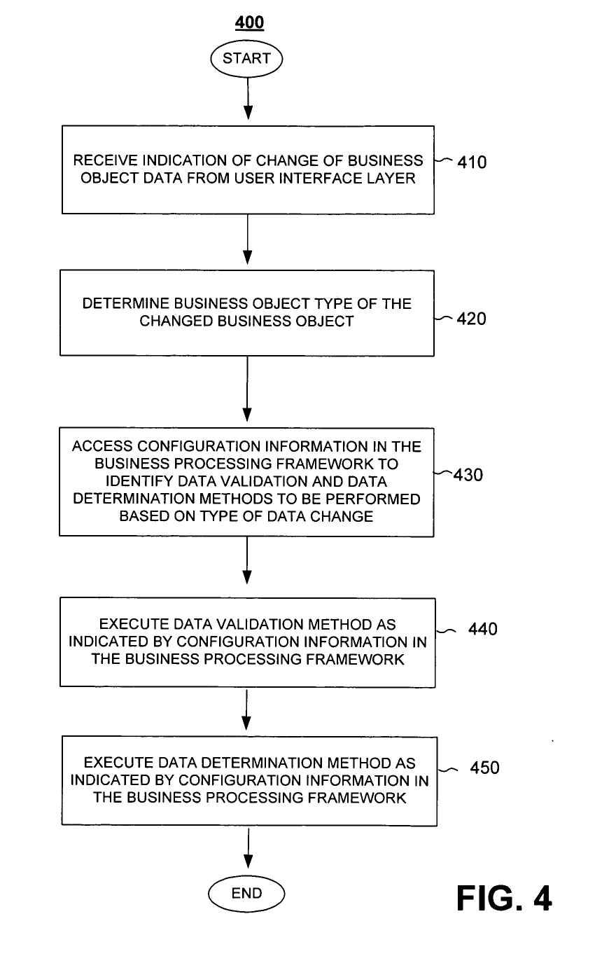

FIGS. 4-6 illustrate a manner in which a business processing framework may control processing of a business object, at runtime, by an application program. FIG. 4 illustrates a process 400 for executing a business process defined by a user. The process 400 may be performed by one or more processors in a system, such as, for example, the system 110 of FIG. 1. The processor is directed by a method, script, or other type of computer program that includes executable instructions for performing the process 400. Examples of such a collection of instructions include the business processing framework 140 of FIG. 1 that is controlled by configuration data 144 defined by an application developer or other type of user. The process 400 may be initiated when a data change execution point that is associated with a business object type is detected, such as by a user interface layer of an application program processing a business object. The process 400 is performed for the particular business object (such as a particular sales order or a particular return request) that is being processed.

The business processing framework receives an indication of change of business object data from the user interface layer of the computer application (step 410). For example, a user may have created a new business object or may have modified some of the data stored by a previously created business object. In some implementations, a business object may be referred to as a business object instance or a document.

The business processing framework determines a business object type of the changed business object (step 420). In some implementations, the business object type may be determined based on the data structure of the business object. Alternatively or additionally, a business object may include an indicator of its business object type.

The business processing framework accesses configuration information in the business processing framework to identify data validation and data determination methods to be performed based on the indicated type of data change the execution point, and the type of business object (step 430). The configuration information of the business processing framework may have been created or modified by an application developer, for example, using the process 200 of FIG. 2 or the user interface 300 in FIG. 3.

The business processing framework then executes the data validation method or methods as indicated by the accessed configuration information in the business processing framework (step 440). When multiple data validation methods are indicated, the business processing framework executes the identified methods according to the execution order included in the configuration information.

After the data validation method or methods have been executed, the business processing framework then executes the data determination method or methods as indicated by the accessed configuration information in the business processing framework (step 450). When multiple data determination methods are indicated, the business processing framework executes the identified methods according to the execution order included in the configuration information. It is important to note that the data validation methods are executed prior to the execution of the data determination methods. Once the business processing framework executes methods as indicated by the configuration information, the process 400 ends.

As the process 400 illustrates, the data validation method is executed in response to detection of a data change, and the data determination method is executed after the data validation method. Data change, data validation and data determination are separated, and the business processing framework controls the sequence such that data validation occurs in response to a data change and data determination occurs after data validation.

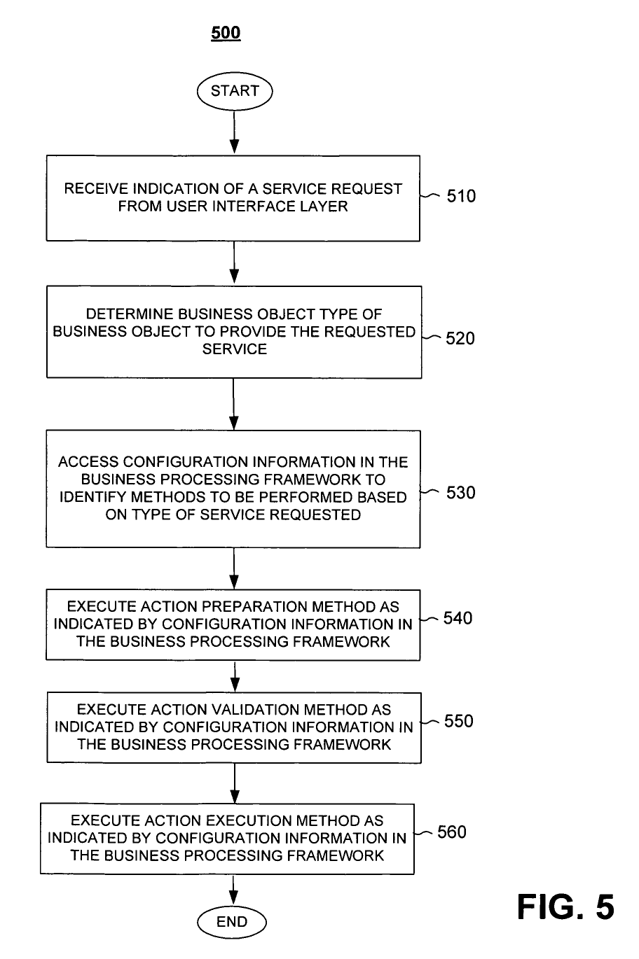

FIG. 5 illustrates a process 500 for executing a business process defined by a user. The business processing framework performs process 500 for a particular business object (such as a particular sales order or a particular return request). In contrast to process 400 of FIG. 4, the process 500 is executed by the business processing framework at runtime in response to a request for a service by a business object.

The process 500 begins when an indication of a service request by a business object is received from the user interface layer of the computer application (step 510). For example, a user may have activated a control, such as a button or menu option, to request performance of a service by a business object. The business processing framework determines a business object type associated with the requested service (step 520).

The business processing framework accesses configuration information in the business processing framework to identify methods to be performed based on the indicated type of service to be performed for the business object type (step 530). The identified methods may be one or more methods related to action preparation, action validation, and action execution, as described more fully below.

The business processing framework then executes the action preparation method or methods as indicated by the accessed configuration information in the business processing framework (step 540). When multiple action preparation methods are indicated, the business processing framework executes the identified methods according to the execution order included in the configuration information. An action preparation method may perform business logic or other types of processing to ensure that data is available for validation and execution. For example, an action preparation method may retrieve or otherwise access other data for which the action is to executed.

After the action preparation method has been executed, the business processing framework executes the action validation method or methods as indicated by the accessed configuration information in the business processing framework (step 550). When multiple action validation methods are indicated, the business processing framework executes the identified methods according to the execution order included in the configuration information. An action validation method may, for example, determine whether the activity to be executed on a business object is permitted, such as by determining whether a user who requested action be performed on a business object has authority to perform the requested action. The action validation method returns an indication whether the action is permitted.

After the action preparation method and action validation method have been executed, the business processing framework executes the action execution method or methods as indicated by the accessed configuration information in the business processing framework (step 560). When multiple action execution methods are indicated, the business processing framework executes the identified methods according to the execution order included in the configuration information. An action execution method performs business logic or other types of processing on a business object. For example, an action execution method may change data in a business object, which, in turn, may result in data validation and data determination methods to be performed, as described previously.

Once the business processing framework executes methods as indicated by the configuration information, the process 500 ends.

As the process 500 illustrates, the action preparation method is executed in response to a request for a service, and the action validation method is executed after the action preparation method. The action execution method only occurs after the action preparation and the action validation have been executed. In this way, action preparation, action validation and action execution determination are separated, and the business processing framework controls the sequence such that action preparation occurs in response to a service request, action validation occurs after action preparation, and action execution occurs after action validation.

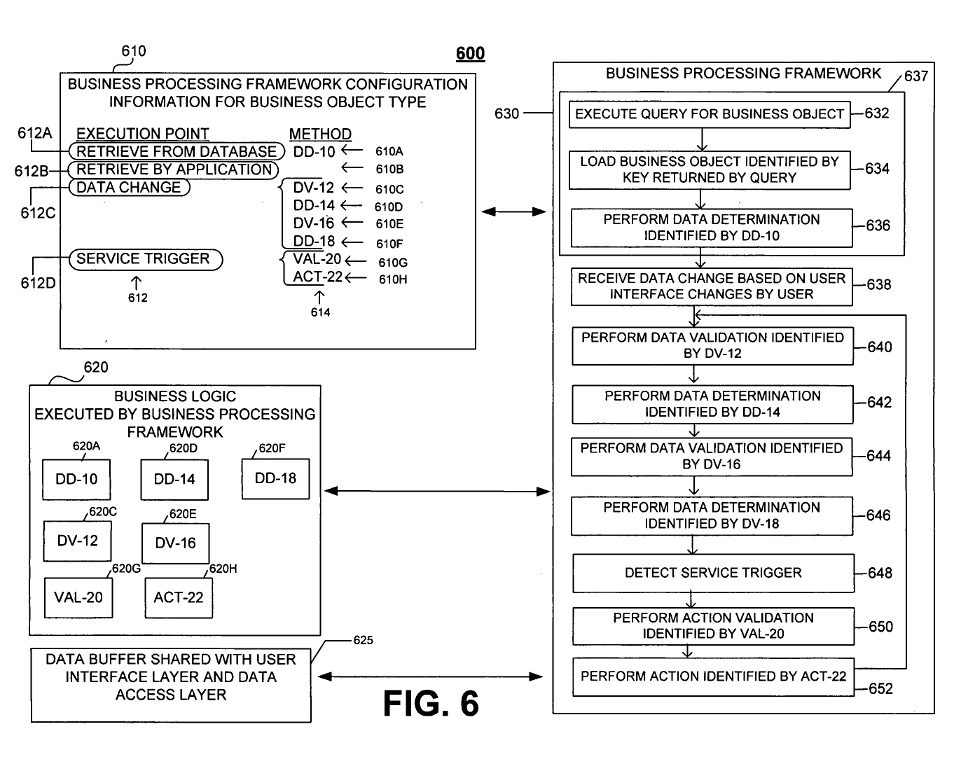

FIG. 6 illustrates an example 600 of how a business processing framework controls processing of a business object at runtime. The example 600 is illustrated with example configuration information 610 related to a particular business object type, business logic 620 executed by the business processing framework, a data buffer 625 that is accessed by the business processing framework, user interface layer and a data access layer, and an exemplary process 630 performed by the business processing framework. The exemplary process 630 illustrates a manner in which the business processing framework may use the process 400 in FIG. 4 and the process 500 in FIG. 5 to process business objects as defined in configuration information 610 by a user, such an application developer. For example, configuration information 610 may have been defined by a user interacting with a process similar to the process 200 in FIG. 2. The process 630 is performed by a business processing framework that interfaces with a user interface layer and a data access layer. To do so, the business processing framework uses a shared portion 625 of transient memory of the computer system executing the process 600. The shared portion of transient memory may be referred to as a buffer or a cache.

The configuration information 610 of the business processing framework is associated with a particular business object type and identifies methods 614, each of which is associated with one of multiple, predetermined execution points 612. The example execution points include retrieving data 612A from the database to the data buffer, retrieving data 612B from the data buffer by the application user interface, changing data 612C by the application user interface, and executing action 612D for a service requested by the application user interface. The business logic 620 includes methods 620A-620H, each of which corresponds to a method included in the configuration information 610 of the business processing framework. Each of the methods 620A-620H may be used at one or more of the execution points 612.

The process example 630 begins when a query is executed to access the business object to be processed (step 632). In some implementations, the query returns only the key of the business object. This may be useful to make the process executed by the business processing framework increase the applicability of the process to more types of business objects. In other words, a query that returns only a key of (or other type of reference to) a business object may be a more generic query than a query that returns the business object itself. The business processing framework loads the business object identified by the key returned by the query to the data buffer 625 (step 634).

It is important to note that, for the business object type, the configuration information 610 does not indicate a method to be performed when the application user interface retrieves the business object from the data buffer 625, as indicated by the fact that no method is associated with the execution point 612B in configuration information 610B. The ability to associate methods with some, but not all, execution points may help to increase flexibility and applicability of the process implementation modeled by the execution points.

In response to and based on configuration information 610A, the business processing framework performs data determination logic identified by DD-10 (step 636). To do so, the business processing framework executes method 620A. The data determination logic of the method 620A may, for example, determine non-persistent data, such as calculate accumulated quantities that are not stored in the database or determine a status indicator related to the business object.

The business processing framework receives a data change based on changes entered by a user thorough the application user interface or programmatic changes made to the data by the application logic (step 638). In any case, the business processing framework detects a change in the data of the business object in the data buffer 625.

Based on configuration information 610C, the business processing framework performs data validation logic identified by DV-12 (step 640). To do so, the business processing framework executes method 620C. The data validation logic of the method 620C may, for example, check the consistency of the data in the business object, such as determining that required data is present or that one attribute does not conflict with another attribute of the business object. A more particular example of data validation is determining whether a product ordered is available for purchase. The method 620C, like all data validation methods, returns only a status indicating whether the business object is consistent. The method 620C, as a data validation method, does not change or modify data of the business object.

Based on configuration information 610D that is also associated with the data change execution point, the business processing framework performs data determination logic identified by DD-14 (step 642). To do so, the business processing framework executes method 620D. The data determination logic of the method 620D may, for example, execute business processing logic based on the validated data change.

Based on configuration information 610E, the business processing framework performs data validation logic identified by DV-16 (step 644). To do so, the business processing framework executes method 620E. The data validation logic of the method 620E may validate the data determined by the method 620D.

Based on configuration information 610F, the business processing framework performs data determination logic identified by DD-18 (step 646). To do so, the business processing framework executes method 620F. The data determination logic of the method 620F may define processing logic that is executed based on successful results of data validation indication that is returned by the method 620D.

In the example 600, the business processing framework then detects a service trigger (step 648). Based on configuration information 610G, the business processing framework performs action validation logic identified by VAL-20 to determine whether the requested service is permitted to be performed (step 650). To do so, the business processing framework executes method 620G. The action validation method 620G may, for example, determine whether the user requesting the service is authorized to perform the action executed in response to the service request.

Based on configuration information 610H that is also associated with the service trigger execution point, the business processing framework performs action processing identified by ACT-22 (step 652). To do so, the business processing framework executes action method 622H. The action method 620H may, for example, change data in the business object, which, in turn, may result in additional data determination and data validation (steps 640-646), based on configuration information 610C-610F.

In some implementations, the steps 632-636 may be executed independently from the execution of steps 638-652. The steps 632-636 may be collectively referred to as a sub-process 637. In one example, the sub-process 637 may be executed to retrieve a business object and calculate data related to attribute values stored by the business object whether or not a user changes data related to the business object.

The example 600 is one illustration of how a business processing framework can be used to provide a transaction processing model for a business object type. The example 600 illustrates a transaction processing model for retrieving, loading and changing a business object. A business processing framework also may be used to provide a transaction processing model for creating and validating a business object. In general, the business processing framework provides a transaction processing model that includes predetermined execution points where one or more methods may be assigned. When a predetermined execution point is reached at runtime, the method or methods are executed for the business object being processed and are executed in the order indicated by the configuration information.

In other implementations, an execution point may be associated with a particular type of data change. This may enable the execution of one or more data determination and/or data validation methods based on particular types of changes in a business object. The ability to identify processing to be performed, for example, based on changes to one or more particular attributes of a business object may be useful. For example, when an application developer is able to identify processing to be performed only for some types of changes to attributes of a business object type (such that different processing is performed for other types of attribute changes of the business object type), the application developer may be able to define types of processing to be performed more discretely than if processing were identified for all types of changes to a business object type.

Although the techniques and concepts describe configuring a business processing framework to control transaction processing at runtime where the data-validation method is executed before the data-determination method, a business processing framework may include multiple execution points such that a business processing framework could be configured to execute a data-determination method before or after a data-validation method. Also, the techniques and concepts generally describe configuring a business processing framework to control transaction processing at runtime using a method as an example of a collection of computer instructions. The techniques and concepts are generally applicable to other examples of computer instructions. A method or another type of computer instructions may be generally referred to as a business process, a computer program, or an instruction module. For example, a data-validation method or another collection of computer instructions that performs a data validation process for a type of a business object may be referred to as a data-validation business process. Similarly, a data-determination method or another collection of computer instructions that performs a data-determination process for a type of business object may be referred to as a data-determination business process.

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device for execution by a programmable processor. A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components. As another example, a screen name is used throughout to represent a unique identifier of an account, but any other unique identifier of an account may be used when linking accounts. Accordingly, other implementations are within the scope of the following claims.

What is claimed is:

1. A computer program product tangibly embodied in an information carrier, the computer program product including instructions that, when executed, cause a business processing component to perform operations comprising:
receiving an indication of a change in data associated with an instance of a business object being processed, the business object instance having multiple attribute values;
receiving an indication of an execution point, wherein the indicated execution point is one of multiple execution points in a predefined processing flow that is applicable to multiple business object types; and
identifying a business object type associated with the business object instance;
accessing user-defined configuration information to determine a data-validation instruction module and a data-determination instruction module, wherein:
the user-defined configuration information is accessed based on i) the change in the data associated with the business object instance, ii) the business object type and iii) the indicated execution point,
the data-validation instruction module returns, to a calling computer application, only a status indicator reflecting consistency of data related to the business object instance, and
the data-determination instruction module makes available, to another instruction module, data related to the business object instance such that the related data made available is different from data that was associated with the business object instance prior to the execution of the data-determination instruction module.

2. The computer program product of claim 1 wherein the instructions, when executed, further cause the business processing component to perform operations comprising:
executing the data-validation instruction module; and
executing the data-determination instruction module.

3. The computer program product of claim 2 wherein the instructions, when executed, cause the business processing component to execute the data-validation instruction module prior to executing the data-determination instruction module.

4. The computer program product of claim 2 wherein the instructions, when executed, cause the business processing component to execute the data-validation instruction module after executing the data-determination instruction module.

5. The computer program product of claim 1 wherein the computer application includes instructions that, when executed, cause business objects to be processed in a manner that is applicable to many different business enterprises.

6. The computer program product of claim 1 wherein the business processing component comprises configuration information, an entry of configuration information being associated with one of multiple business object types, with one of multiple execution point types, and a type of multiple types of data changes.

7. The computer program product of claim 1 wherein the business processing component is situated between a user interface layer and a data access layer such that the business processing component communicates with at least one user interface instruction module and communicates with at least one data access instruction module.

8. The computer program product of claim 1 wherein the data change comprises a change of an attribute value of the business object.

9. The computer program product of claim 1 wherein the related data made available comprises an attribute determined based on an attribute of the business object instance.

10. The computer program product of claim 1 wherein:
the business object instance comprises one or more subcomponents, with each subcomponent having one or more associated attribute values, and
the data change comprises a change of an attribute value of one of the one or more sub-components of the business object instance.

11. The computer program product of claim 10 wherein the data-determination instruction module makes available a subcomponent of the business object instance having one or more associated attribute values.

12. The computer program product of claim 1 wherein the instructions that, when executed, further cause the business processing component to perform operations comprising:
receiving a trigger for a service associated with the business object type;
accessing user-defined configuration information to determine an action-validation instruction module and an action-execution instruction module, wherein:
the action-validation instruction module is associated with the triggered service,
the action-execution instruction module is associated with the triggered service,
the action-validation instruction module returns an indication whether the action-execution instruction module is permitted to be performed on the business object instance; and
executing the determined action-validation instruction module associated with the service prior to executing the determined action-execution instruction module.

13. The computer program product of claim 12 wherein, the instructions that, when executed, further cause the business processing component to perform operations comprising:
accessing user-defined configuration information to determine an action-preparation instruction module that is associated with the triggered service wherein the action-preparation instruction module retrieves additional data related to the business object instance; and
executing the determined action-preparation instruction module associated with the service prior to executing the determined action-validation instruction module.

14. The computer program product of claim 1 further comprising instructions that, when executed, cause a business processing configuration component to perform operations comprising:
receiving user-defined configuration information including:
an indication of a data-validation instruction module,
an indication of a data-determination instruction module,
an indication of a type of change,
an indication of a business object type,
and an indication of an execution point; and
storing the user-defined configuration information for later use.

15. The computer program product of claim 14 wherein the instructions that, when executed, further cause the business processing configuration component to perform operations comprising:
receiving user-defined configuration information including:
an indication of an action-preparation instruction module,
an indication of an action-execution instruction module,
an indication of a trigger, and
an indication of a business object type; and
storing the user-defined configuration information for later use.

16. A method for defining transaction processing, the method comprising:
receiving an indication of a change in data associated with an instance of a business object being processed, the business object instance having multiple attribute values;
receiving an indication of an execution point of multiple execution points in a predefined processing flow;
identifying a business object type associated with the business object instance; and
accessing user-defined configuration information to determine a data-validation instruction module and a data-determination instruction module, wherein:
the user-defined configuration information is accessed based on i) the change in the data associated with the business object instance, ii) the business object type and iii) the execution point,
the data-validation instruction module returns, to a calling computer application, only a status indicator reflecting consistency of data related to the business object instance, and
the data-determination instruction module makes available, to another instruction module, data related to the business object instance such that the related data made available is different from data that was associated with the business object instance prior to the execution of the data-determination instruction module.

17. The method of claim 16 wherein the data change comprises a change of an attribute value of the business object.

18. The method of claim 16 wherein the related data made available comprises an attribute determined based on an attribute of the business object instance.

19. The method of claim 16 wherein:
the business object instance comprises one or more subcomponents, with each subcomponent having one or more associated attribute values, and
the data change comprises a change of an attribute value of one of the one or more sub-components of the business object instance.

20. The method of claim 19 wherein the data-determination instruction module makes available a subcomponent of the business object instance having one or more associated attribute values.
